(19) United States
(12) Patent Application Publication
(10) Pub. No.: US 2020/0215767 A1
(43) Pub. Date: Jul. 9, 2020

(54) PRODUCTION SYSTEM FOR LAYING FIBER TAPES

(71) Applicant: Fill Gesellschaft m.b.H., Gurten (AT)

(72) Inventor: Norbert DANNINGER, Andorf (AT)

(73) Assignee: Fill Gesellschaft m.b.H., Gurten (AT)

(21) Appl. No.: 16/645,103

(22) PCT Filed: Sep. 4, 2018
(86) PCT No.: PCT/AT2018/060199

§ 371 Date: Mar. 6, 2020

(30) Foreign Application Priority Data
Sep. 8, 2017 (AT) A50754/2017

(51) Int. Cl. B29C 70/38; B29C 70/54

(52) U.S. Cl. CPC B29C 70/388; B29C 70/228; B29C 70/545

(57) ABSTRACT

The invention relates to a production system (1) for laying fiber tapes (2). The production system (1) comprises:
a laying device (6) having an unwinder receptacle (9) and at least two unwinders (8) arranged next to one another on the unwinder receptacle (9), which unwinders (8) each comprises a receiving device (10) for receiving a raw material reel (11) and a cutting unit (27) for cutting the fiber tape (2);—
a depositing device (7) having a depositing surface (12) for receiving the fiber tape (2) unwound from the raw material reel (11), the depositing surface (12) of the depositing device (7) and the unwinder (8) of the laying device (6) being displaceable relative to each other in the laying direction (18), whereby the fiber tape (2) can be unwound in stripes onto the depositing surface (12).

The at least two unwinders (8) are coupled to an unwinder receptacle (9) of the laying device (6) by means of a linear guide (17) and are movable independently of each other in the laying direction (18) relative to the unwinder receptacle (9).

The invention relates to a production system for laying fiber tapes and a method for laying fiber tapes.

From DE 10 2014 101 445 A1 a method for constructing a laminate and an associated tape laying device is known. In this process, a tape provided with binder and/or matrix materials is fed to a depositing device. The supplied tape is laid by means of the depositing device until the tape structure corresponding to the laminate is obtained from tape laid next to and on top of one another, whereby tape laid next to one another defines a tape layer of a tape structure. The tape structure is fed to an ultrasonic excitation device and the binder and/or matrix materials are successively plasticized and the individual layers of tape are thus joined together.

DE 10 2014 201 060 A1 is the name of a fiber laying machine for the production of fiber scrims. The fiber laying machine has a tool table for positioning a molding tool, which are can be moved linearly in an x-direction by means of an x-slide and can be pivoted about a vertical pivot axis. Arranged above the tool table is a fiber laying head, which is displaceable linearly and transversely to the x-direction by means of a y-slide.

The devices known from DE 10 2014 101 445 A1 and DE 10 2014 201 060 A1 have the disadvantage that laying of fibers with such devices has a long process time.

Further devices for the production of fiber fabrics are known from WO 2017/084823 A1, US 2010/193103 A1 and US 2014/299266 A1.

The object of the present invention was to overcome the disadvantages of the state of the art and to provide a device and a method by means of which the laying of fibers and/or the creation of tape structures is simplified.

This object is achieved by a device and a method according to the claims.

According to the invention, a production system is formed for laying fiber tapes. The production system comprises:
a laying device having an unwinder receptacle and at least two unwinders arranged next to one another on the unwinder receptacle, which unwinders each comprise a receiving device for receiving a raw material reel and a cutting unit for cutting the fiber tape;—
a depositing device with a depositing surface for receiving the fiber tape unwound from the raw material reel, the depositing surface of the depositing device and the unwinder of the depositing device being movable relative to one another in the laying direction, whereby the fiber tape can be unwound onto the depositing surface in strips. The at least two unwinders are each coupled to an unwinder receptacle of the laying device by means of a linear guide and are displaceable independently of one another in the laying direction relative to the unwinder receptacle.

The advantage of the production system according to the invention is that it is robust and less prone to failure. In addition, by means of the production system according to the invention, the individual fiber tapes can be laid in a short process time on the depositing surface to form a scrim.

Furthermore, it may be useful if the unwinders each have a welding head which is formed for welding two fiber tapes laid one on top of the other. The advantage of this measure is that the individual fiber tapes of the individual fiber tape layers can adhere to one another. Here, it is not absolutely necessary for the welding to have a high durability, but it can be provided that the welding serves for pure stabilization.

Furthermore, it may be provided that the welding head has at least one pressing-down skid and in particular a heating element for heating the pressing-down skid. The advantage here is that such a thermal welding head can be of simple design and, in addition, a thermal welded joint can have sufficient stability and can be produced in a simple manner.

Alternatively, the welding head may be formed for ultrasonic welding, in particular by means of ultrasonic sonotrodes or friction welding, or also for resistance welding using electric current.

In addition, it may be provided that the depositing surface of the depositing device is height-adjustable in a vertical direction so that the distance of the depositing surface to the unwinders can be adapted. The advantage of this measure is that it allows the depositing surface to be adapted to the respective fiber tape layer to be laid.

As an alternative or in addition to this, it may be provided that the unwinders are movable in vertical direction.

Another advantage is a specification according to which it can be provided that the depositing surface of the depositing device is displaceable in transverse direction to the laying direction. The advantage of this measure is that only every second fiber tape has to be laid in a first laying step and the missing fiber tapes in between can be laid in a subsequent laying step.

According to a further development, it is possible for the depositing surface of the depositing device to be rotatable about an axis of rotation perpendicular to the depositing surface. The advantage here is that this measure allows the fiber tapes of the individual fiber tape layers to be laid at different angles to one another, in order to obtain a scrim in the form of a check pattern, for example.

It may also be useful if each of the individual unwinders is coupled to a drive unit, in particular a linear motor, by means of which the unwinders can be displaced independently of one another in the laying direction. The advantage here is that this measure allows the individual unwinders to be stopped at different times to fix the fiber tape to the depositing surface, whereby the remaining unwinders are not slowed down by stopping one unwinder. This can reduce the overall process time. This is particularly advantageous if the fiber tape layer has a complex outer contour and the start and end of the individual fiber tapes are offset from one another.

In addition, it may be provided that each of the unwinders is assigned its own integrated circuit, the individual integrated circuits being coupled to a higher-level central control. The advantage here is that the individual actuators of the unwinders do not have to be controlled by the higher-level central control, but that the computing tasks can be performed in the integrated circuit.

Furthermore, a cooling device can be arranged in the area of the cutting unit, by means of which the fiber tape can be cooled. This measure allows the fiber tape to be cooled locally to make it more brittle for the cutting process. This is particularly advantageous if the fiber tape is made of a tough material.

According to the invention, a method for laying fiber tapes, in particular using a production system according to one of the preceding claims, is provided. The method comprises the following steps:—
providing a laying device with at least two unwinders arranged next to one another, which unwinders each comprise a receiving device for receiving a raw material reel of a fiber tape and a cutting unit for cutting the fiber tape, wherein the at least two unwinders are each coupled by means of a linear guide to an unwinder receptacle of the laying device and can be displaced independently of one another in the laying direction relative to the unwinder receptacle;—
providing a depositing device with a depositing surface;
applying the fiber tape of a first of the unwinders onto the depositing surface of the depositing device;
fixing the fiber tape of the first unwinder on the depositing surface of the depositing device;
unwinding the fiber tape of the first unwinder by displacing the first unwinder in the laying direction, the fiber tape being unwound onto the depositing surface by being fixed on the depositing surface and being drawn off therefrom by the displacement of the first unwinder;
cutting the fiber tape to length by means of the cutting unit of the first unwinder;
applying the fiber tape of a second of the unwinders onto the depositing surface of the depositing device;
fixing the fiber tape of the second unwinder to the depositing surface of the depositing device;
unwinding the fiber tape of the second unwinder by displacing the second unwinder in the laying direction, wherein the fiber tape is thereby unwound onto the depositing surface in such a way that it is fixed on the depositing surface and is drawn off from the latter by the displacement of the second unwinder;
cutting the fiber tape to length by means of the cutting unit of the second unwinder, wherein the individual steps of the first unwinder and the second unwinder can be started at different times or at the same time and the first unwinder and the second unwinder are displaceable independently of one another.

The advantage of the method according to the invention is that the process time for producing a fiber tape layer can be shortened. In particular, it is intended that the individual unwinders can be started with a time delay, but that they are displaceable independently of one another, so that the laying process can be carried out individually for each fiber tape. As a result, the downtimes of the unwinder required on a fiber tape are not transferred to other unwinders.

In accordance with an advantageous further development, it can be provided that the fiber tapes of a first fiber tape layer are fixed directly on the depositing surface of the depositing device on an intermediate layer and then the fiber tapes of a second fiber tape layer are applied to the fiber tapes of the first fiber tape layer, wherein each of the fiber tapes of the second fiber tape layer is at least partially integrally bonded to fiber tapes of the first fiber tape layer by means of a welding head arranged on the unwinder. This has the advantage that the fiber tapes of the individual fiber tape layers adhere to one another such that the thus produced fabric can be easily manipulated.

In particular, it may be advantageous if the number of unwinders is less than the number of fiber tapes provided per fiber tape layer and that in a first method step only every second fiber tape of a fiber tape layer is laid, then the depositing surface of the depositing device is displaced in transverse direction to the laying direction and then in a further method step the intermediate, missing fiber tapes of a fiber tape layer are laid. An advantage here is that this measure allows the width of the unwinders to be much greater than the width of the individual fiber tapes. This means that the unwinders can be of robust design or have all necessary components. The second method step of interposing the still missing fiber tapes allows a complete fiber tape layer to be laid.

Furthermore, it may be provided that the residual length of the fiber tape on the raw material reel is constantly monitored and that before the start of the laying of the fiber tapes it is calculated whether the residual length of the fiber tape on the raw material reel is sufficient for the upcoming laying process, wherein a raw material reel in a reel store is exchanged as required. The advantage of this measure is that the fiber tape on the raw material reel does not run out during the laying process. The monitoring of the residual length of the fiber tape can be done by means of a sensor, for example. Alternatively, the residual length of the fiber tape can also be determined by calculating the consumption on the basis of the fiber tapes already laid.

In addition, it can be provided that the stock of raw material reels in a reel store is monitored, whereby when a predefined minimum number of raw material reels is reached, an order process is triggered in which a command is sent from the central control to a computer located in a network. The advantage of this measure is that the stock of raw material reels in the reel store does not have to be monitored by the machine operator, but that the order process is triggered automatically. This measure reduces the risk of machine downtime due to human failure.

It is also advantageous to provide for a measure whereby, when the fiber tape is fixed on the depositing surface of the depositing device, the unwinders are stopped or at least greatly decelerated in their traversing movement. As a result, the starting position or the end position of the fiber tapes can be fixed in a precise position.

Scrims are understood to be an arrangement of several fiber tape layers arranged one above the other, whereby the individual fiber tapes of the individual fiber tape layers may be arranged in the same and/or different directions. The individual fiber tape layers do not necessarily have to be fixed to each other.

For a better understanding of the invention, it is explained in more detail with reference to the following figures.

They each show in a greatly simplified, schematic illustration:

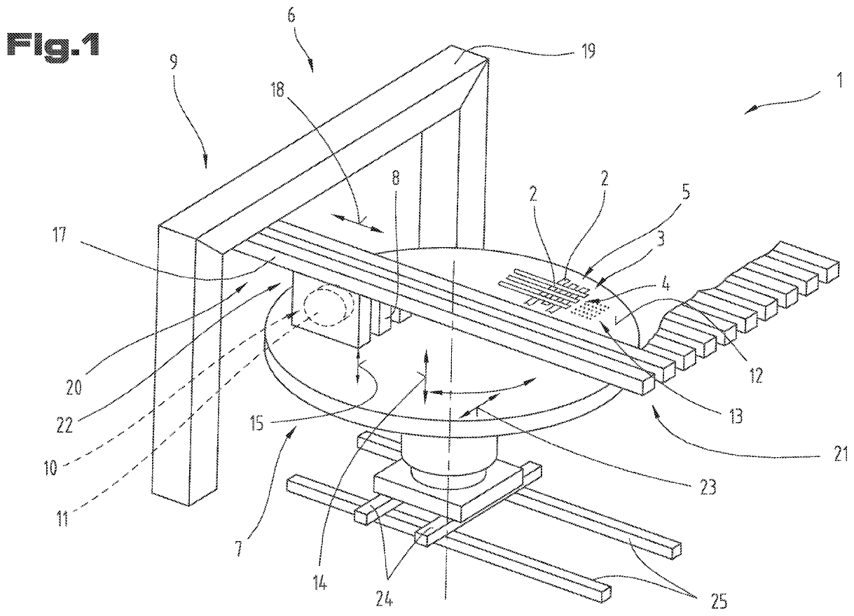

FIG. 1 a schematic illustration of an exemplary embodiment of a production system in a perspective view;

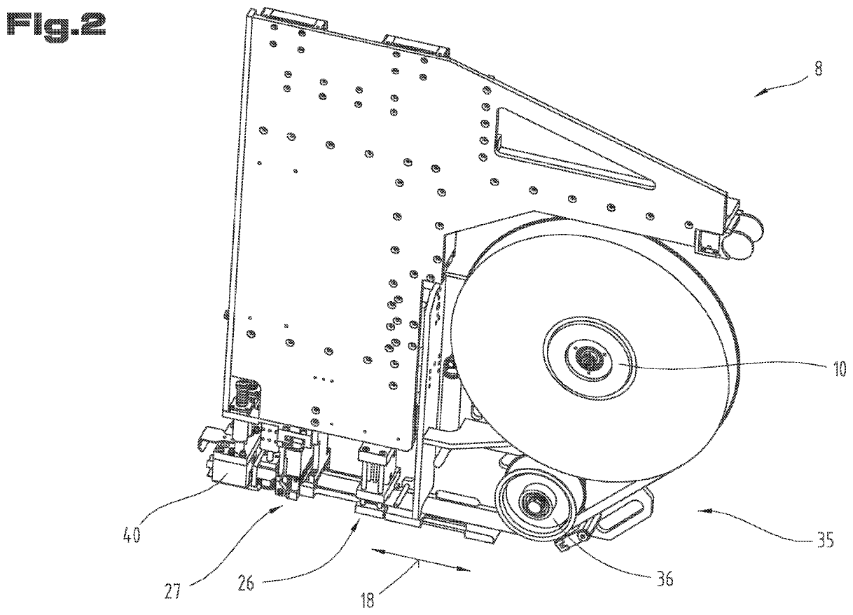

FIG. 2 a first exemplary embodiment of an unwinder in a perspective detailed view;

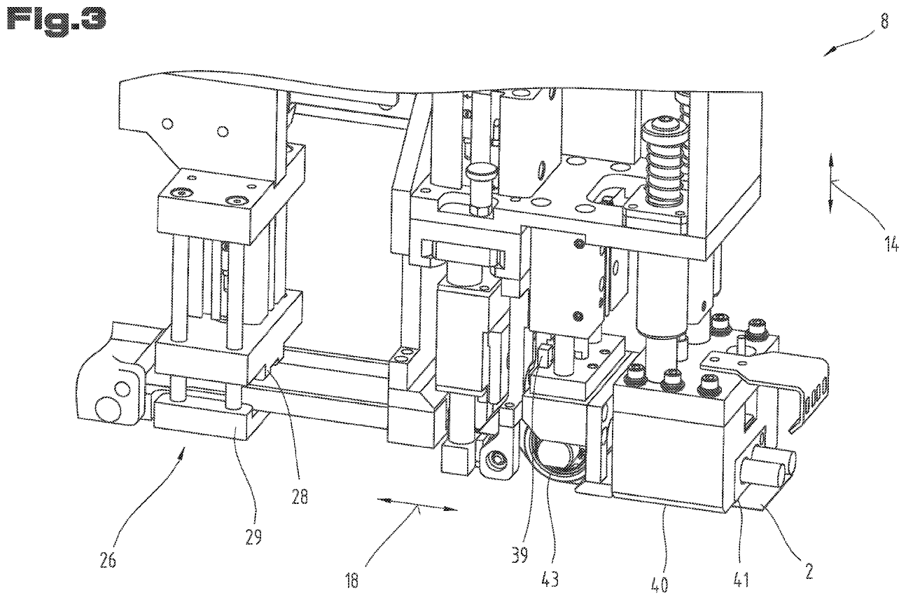

FIG. 3 the first exemplary embodiment of the unwinder in a perspective detail view;

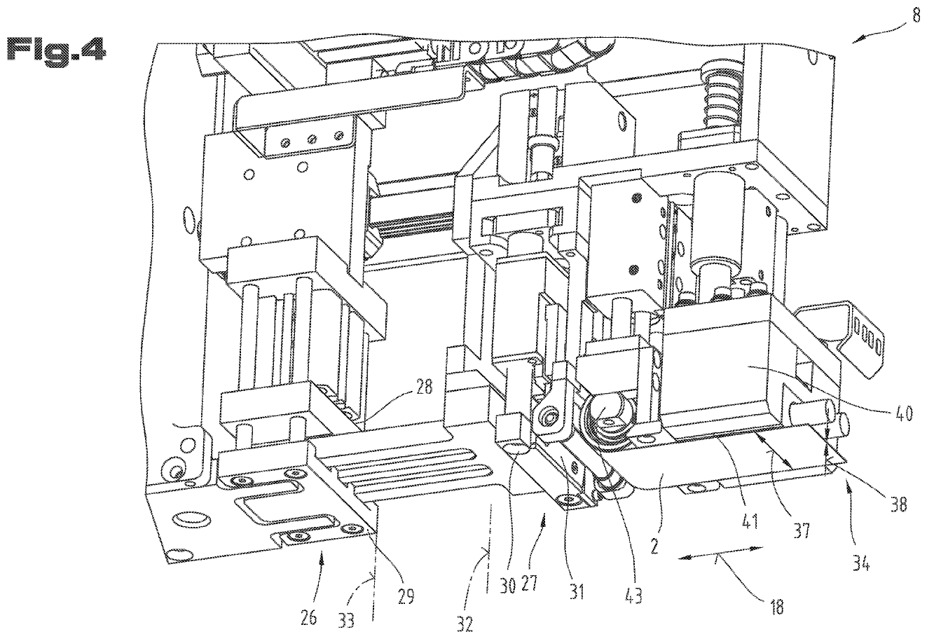

FIG. 4 the first exemplary embodiment of the unwinder in a perspective detail view;

FIG. 5 a first exemplary embodiment of an arrangement of unwinders in a top view;

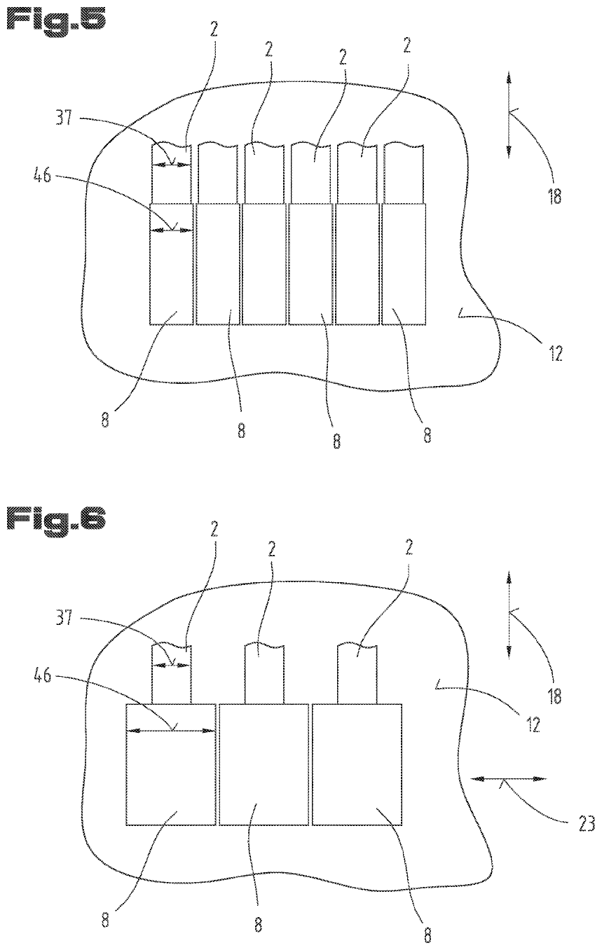

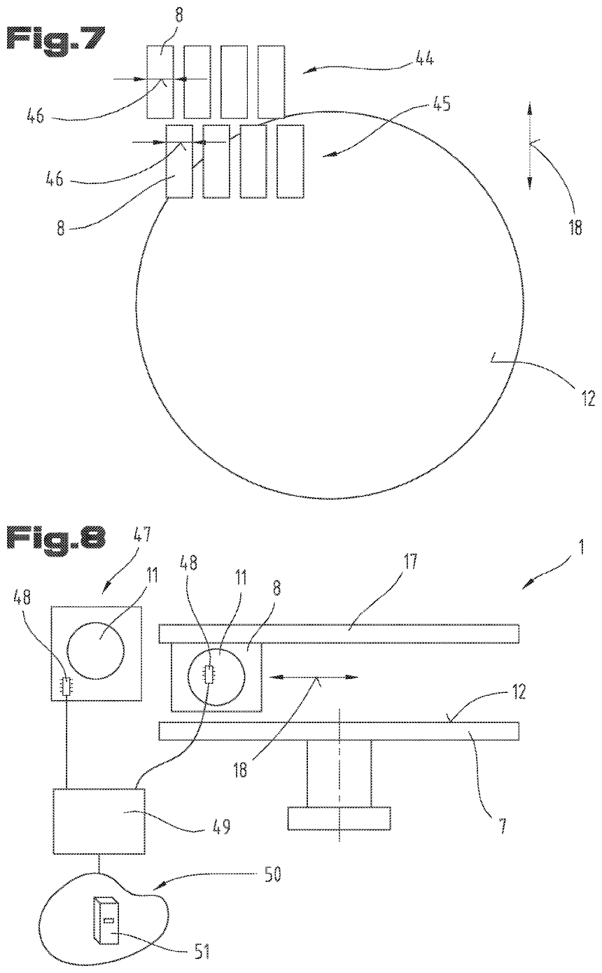

FIG. 6 a second exemplary embodiment of an arrangement of unwinders in a top view;

FIG. 7 a third exemplary embodiment of an arrangement of unwinders in a top view;

FIG. 8 another exemplary embodiment of a production system with a reel store in a side view;

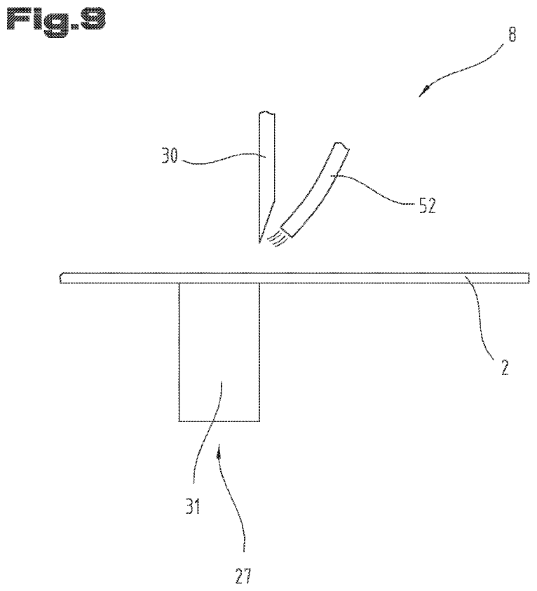

FIG. 9 an exemplary embodiment of a cutting unit with a cooling device.

As an introduction, it should be noted that in the differently described embodiments, identical parts are provided with the same reference symbols or the same component designations, whereby the disclosures contained in the entire description can be transferred analogously to identical parts with the same reference symbols or the same component designations. The positional information selected in the description, e.g. top, bottom, side, etc., are also related to the figure described and shown directly and must be appropriately transferred to the new position when the position is changed.

FIG. 1 shows a perspective view of a production system 1 for laying fiber tapes 2: By means of the production system 1, the fiber tapes 2 can be laid into a first fiber tape layer 3. The fiber tape layer 3 can have a contoured outer border adapted to the respective application by using individual fiber tapes 2 in the production system 1. Furthermore, it may be provided that a second fiber tape layer 4 or also additional fiber tape layers are laid on top of one another in the production system 1 and are thus processed further into a scrim 5.

The fiber tapes 2 which are processed in the production system 1 can be formed, for example, in the form of dry fibers. Furthermore, it is also possible that the fiber tapes 2 are formed as pre-impregnated fibers which contain reaction resins consisting of a usually highly viscous, but not yet polymerized duopolistic matrix and/or a thermoplastic polymer matrix, or else of another matrix. Furthermore, the fiber tapes 2 can have adhesive layers by means of which individual fiber tape layers 3, 4 can adhere to one another.

The production system 1 comprises a laying device 6 for laying the fiber tape 2 and a depositing device 7 for receiving the laid fiber tapes 2. Furthermore, a manipulation device can be provided by means of which the fiber tapes 2 or fiber tape layers 3 laid on the depositing device 7 can be removed from the depositing device 7.

The laying device 6 comprises at least two unwinders 8, which are arranged next to one another on an unwinder receptacle 9.

The unwinders 8 each have a receiving device 10 for receiving a raw material reel 11.

As shown in FIG. 1, the depositing device 7 has a depositing surface 12 on which the fiber tape 2 unwound from the unwinder 8 can be deposited and positioned.

In order to be able to fix the fiber tape 2 to the depositing surface 12, it may be provided that several passage openings 13 are formed on the depositing surface 12, through which air is sucked out, as a result of which a negative pressure can be applied onto the depositing surface 12. In particular, it may be provided that the passage openings 13 are flow-connected with a device for generating negative pressure. Such a device for generating negative pressure can be realized, for example, by an axial or radial blower.

In particular, it may be provided that the depositing device 7 has a rotary table on which the depositing surface 12 is formed. The depositing surface 12 can be displaceable in a vertical direction 14, so that a distance 15 between the unwinder 8 and the depositing surface 12 can be varied. This measure allows the depositing surface 12 to be adapted to different fiber tapes 2 or to the laying in the respective fiber tape layer 3, 4.

Furthermore, it can be provided that the depositing surface 12 is arranged so that it can be rotated about an axis of rotation 16, so that the orientation of the fiber tapes 2, which are placed on the depositing surface 12, can be changed. It is thus possible that in several layers of fiber tapes 2 lying on top of one another, these are formed in different directions of orientation. For example, a check pattern or diamond-shaped pattern can be achieved.

As an alternative or in addition to the adjustment of the depositing surface 12 in vertical direction 14, it can also be provided that the linear guides 17 and thus the unwinders 8 are displaceable in vertical direction 14.

The unwinders 8 are each arranged on a linear guide 17, by means of which they are displaceable in laying direction 18. In particular, it may be provided that each of the unwinders 8 is arranged on its own linear guide 17. Furthermore, it may also be provided that the unwinders 8 are displaceable relative to one another in the transverse direction 23. Furthermore, it can also be provided that all unwinders 8 are displaceable together in the transverse direction 23. This allows the belt widths to be adapted or the fiber belts 2 to be laid in a curved manner.

Furthermore, it can be provided that the unwinder receptacle 9 has one or more portals 19, on which the individual linear guides 17 are arranged. For the sake of clarity, FIG. 1 only shows one portal 19, which is arranged in the area of a first linear guide end 20. Of course it can also be provided that a portal 19 is also formed in the area of the second linear guide end 21. In addition, one or more portals 19 can also be formed between the two linear guide ends 20, 21.

Instead of the portals 19, all other mounting options can of course also be formed to receive the linear guides 17.

A drive unit 22 can be formed to displace the unwinders 8 in laying direction 18 along the linear guides 17. In a first exemplary embodiment, the drive unit 22 may be formed as a linear motor, for example, whereby the stator may be integrated directly into the linear guide 17.

Alternatively, it may be provided, for example, that the drive unit 22 has a traction means which is coupled with the unwinder 8 and is tensioned between the two linear guide ends 20, 21 of the linear guide 17. A drive motor can be arranged in the area of one of the linear guide ends 20, 21.

Of course, the drive unit 22 can also have a gear wheel or other means which serve to displace the unwinders.

Furthermore, it may be provided that the depositing surface 12 can be displaceable in a transverse direction 23, which is arranged transversely to the laying direction 18. A transverse direction guide 24 can be formed for this purpose. The transverse direction guide 24 can, for example, be formed by two linear guides, as shown in FIG. 1.

Furthermore, it may be provided that the depositing device 7 is coupled with a longitudinal direction guide 25, by means of which the depositing surface 12 can be moved in the laying direction 18. This measure allows the depositing device 7 to be moved out of the area of the laying device 6 so that the scrim 5 laid on the depositing surface 12 can be removed from the depositing surface 12 by means of a manipulation device. The scrim 5 can then be inserted into a press mold, in particular a 3D mold, using the manipulation device.

In FIG. 2 the unwinder 8 is shown in a first perspective view. FIGS. 3 and 4 show the unwinder 8 in further perspective views, details of the unwinder 8 being apparent in FIGS. 3 and 4. For identical parts, the same reference symbols or component designations are used as in the respective preceding figures. In order to avoid unnecessary repetition, reference is made to the detailed description in the respective preceding figures. The unwinder 8 is described on the basis of an overview of FIGS. 2 to 4.

The unwinder 8 comprises a clamping unit 26 for fixing the fiber tape 2 to be unwound from the raw material reel 11 and a cutting unit 27 for cutting the fiber tape 2. In particular, it may be provided that the clamping unit 26 has a clamping jaw 28 and that the fiber tape 2 is clamped between clamping jaw 28 and a counter-holder 29. The clamping jaw 28 can be mounted on an actuator such as a pneumatic cylinder.

Furthermore, it may be provided that the cutting unit 27 is formed in the form of a guillotine, whereby the cutting unit 27 may comprise a cutting knife 30 and a counter-holder 31. The counter-holder 31 of the cutting knife 30 can be positioned directly next to the counter-holder 29 of the clamping jaw 28 next to the latter.

Furthermore, it may be provided that the cutting knife 30 is arranged on an actuator, such as a pneumatic cylinder, which allows the cutting knife 30 to be moved relative to the counter-holder 31, thus allowing the cutting movement to be carried out.

It is also possible that the clamping unit 26 is arranged on the unwinder 8 so that it is displaceable in the laying direction 18 relative to the cutting unit 27. This allows the clamping unit 26 to be moved back and forth between an advanced ejection position 32 and a retracted basic position 33. This is necessary, in particular, in order to provide a fiber tape attachment 34 after cutting off the fiber tape 2, to which the fiber tape 2 can be fixed for unwinding another fiber tape strip.

Alternatively or additionally it can also be provided that the cutting unit 27 is displaceable in laying direction 18.

Furthermore, it may be provided that in the unwinder 8 the fiber tape 2 unwound from the raw material reel 11 is guided through a deflection reel arrangement 35, which has at least one deflection reel 36. As seen in the course of the fiber tape 2, the clamping unit 26 can be arranged next to the deflection reel arrangement 35 and the cutting unit 27 can be arranged further along the course of the fiber tape 2.

The fiber tape 2 has a width 37, which can be between 2 mm and 200 mm, in particular between 5 mm and 100 mm, preferably between 10 mm and 50 mm. Furthermore, fiber tape 2 has a fiber tape thickness of 38, which can be between 0.03 mm and 10 mm, in particular between 0.5 mm and 5 mm, preferably between 0.8 mm and 3 mm.

As can be seen in FIG. 3, an optical unit 39 can be provided for tape detection. The optical unit 39 can preferably be arranged next to the cutting unit 27 on the unwinder 8, so that the optical unit 39 can be used to determine the length of an unwound fiber strip when unwinding the fiber tape 2. Furthermore, the optical unit 39 can be formed in such a way that the quality and/or dimensions of the fiber tape 2 can be checked. In addition, the optical unit 39 can be used to identify the fiber tape 2. Furthermore, the optical unit 39 can be used to check the width of the fiber tape 2 or to control the run of the fiber tape 2.

Alternatively or additionally, it may be provided that a recording or measuring system is installed in the deflection reel 36 or in the receiving device 10 for the raw material reel 11, by means of which the length of the unwound tape can be detected.

Furthermore, it may be provided that a braking unit is installed in the receiving device 10 for the raw material reel 11, so that the raw material reel 11 can be braked and thus an undesired unwinding of the fiber tape 2 can be prevented. The tension of the fiber tapes 2 can be kept constant by means of the brake unit. In this case, the decrease of the unwinding diameter of the fiber tape 2 from the raw material reel 11 can be taken into account.

In an alternative embodiment variant, it may be provided that the receiving device 10 for the raw material reel 11 comprises a drive unit by means of which the raw material reel 11 can be driven or braked as required. As a result, an increased tensile load on the fiber tape 2 can be stopped at elevated processing speeds, as a result of which the processing speeds can be further increased.

Furthermore, it may be provided that the unwinder 8 comprises a welding head 40, which is used for welding the individual fiber tapes 2 of the individual fiber tape layers 3, 4. In particular, it may be provided that the welding head 40 presses in vertical direction 14 onto a surface of the fiber tape unwound from the raw material reel 11. In this case, the welding head can be equipped with 40 press-down skids 41, which apply a locally higher surface pressure to the fiber tape 2. Furthermore, a heating element 42 can be provided in the welding head 40, which can be used to heat the press-down skids 41.

The heating element 42, for example, can be formed as resistance heater.

In a further embodiment variant it may also be provided that the welding head 40 is formed for ultrasonic welding or friction welding of the individual fiber tapes 2.

Furthermore, a hold-down reel 43 can be provided, which serves to press the fiber tape 2 against the depositing surface 12. The hold-down reel 43 can also be used to weld fiber tape 2 according to the mechanisms described in the welding device.

FIG. 5 shows a further and, where appropriate, self-contained embodiment of the production system 1, again using the same reference symbols or component designations for identical parts as in the preceding FIGS. 1 to 4. In order to avoid unnecessary repetition, reference is made to the detailed description in the preceding FIGS. 1 to 4.

As can be seen from FIG. 5, it may be provided that the individual unwinders 8 are arranged adjacent to one another in such a way that the individual fiber tapes 2 can be deposited on the depositing surface 12 at a predetermined distance from one another, which corresponds to the final distance of the fiber tapes 2 in one of the respective fiber tape layers 3, 4. This means that a fiber tape layer 3, 4 can be finished in each case with only one laying process.

FIG. 6 shows a further and, where appropriate, self-contained embodiment of the production system 1, again using the same reference symbols or component designations for identical parts as in the preceding FIGS. 1 to 5. In order to avoid unnecessary repetition, reference is made to the detailed description in the preceding FIGS. 1 to 5.

As can be seen from FIG. 6, it can be provided that the individual unwinders 8 have such a large width 46 or are arranged relative to one another in such a way that a gap is formed between the individual, laid fiber tapes 2 during the first laying step. This gap between the individual fiber tapes 2 can correspond either to a single or a multiple tape width 37 of the fiber tape 2. Of course, a distance between the individual fiber tapes 2 can also be provided. After the first laying step, the depositing surface 12 is displaceable in transverse direction 23, so that in a second method step the fiber tapes 2 can be laid into the gaps. If the gaps correspond to a multiple of the fiber tape width 46 plus the gap between the individual fiber tapes, then the displacement of the depositing surface 12 in transverse direction 23 must be repeated a corresponding number of times.

A possible process sequence for laying fiber tapes 2 is explained on the basis of an overview of FIGS. 1 to 6.

As a starting condition it can be provided that all unwinders 8 are arranged in the area of the first linear guide end 20 of the linear guides 17 and that the depositing surface 12 of the depositing device 7 is empty. In this case, the fiber tapes 2 can be accommodated in the unwinder 8 in such a way that a tape attachment 34 is arranged at least under the hold-down reel 43.

In a first method step, the individual unwinders 8 are displaceable independently of one another in laying direction 18 towards the second linear guide end 21. When the respective unwinders 8 reach their starting position specified for the respective contour to be produced, they can be stopped or slowed down in their travel speed.

In order to be able to detachably attach the fiber tape attachment 34 to the depositing surface 12, the hold-down reel 43 can now be pressed against the fiber tape 2. In addition or alternatively, a vacuum can be applied onto depositing surface 12. This fastening process can be repeated independently on all unwinders 8. Furthermore, it may also be provided that an intermediate layer, e.g. a Teflon film, is placed between the depositing surface 12 and the first fiber tape layer 3.

In a subsequent method step, the individual unwinders 8 can again be moved independently of one another in the direction of the second linear guide end 21. Due to the relative displacement of the unwinders 8 with respect to the depositing surface 12 and the fact that the fiber tape attachment 34 is fixed to the depositing surface 12, the fiber tape 2 is pulled off the raw material reel 11 due to the relative movement between the unwinder 8 and the depositing surface 12.

When the unwinders 8 reach their individual end position, the unwinders 8 can be stopped again. Subsequently, the clamping unit 26 can be activated so that the fiber tape 2 is clamped. Afterwards, the fiber tape 2 can be cut off by means of the cutting unit 27. In a further method step the depositing surface 12 can be lowered in vertical direction 14. In a subsequent process, the individual unwinders 8 are displaceable back to their starting position or to the position of their next laying start.

At the same time or at a later time, the clamping unit 26 is displaceable from its basic position 33 to an ejection position 32, so that a new tape attachment 34 can be inserted under the hold-down reel 43. Furthermore, a fixing unit for clamping the fiber tape in the area of the hold-down reel 43 can be provided.

The further method step is dependent on how far the individual unwinders 8 are spaced apart from one another. If, as shown in FIG. 5, the individual unwinders 8 are spaced apart from one another in such a way that all the fiber tapes 2 of the first fiber tape layer 3 can already be laid, it can be continued with the method step described in more detail for laying the second fiber tape layer 4

If, as shown in FIG. 6, the unwinders 8 are spaced apart from one another in such a way that, for example, only every second fiber tape 2 can be laid, in a subsequent method step, the depositing surface 12 must be moved in the transverse direction 23 so that the fiber tapes 2 that are still missing can be placed on the depositing surface 12. The actual laying process can be carried out according to the method steps already described.

For laying the second fiber tape layer 4, the depositing surface 12 can be rotated about the axis of rotation 16 so that the fiber tapes 2 of the second fiber tape layer 4 can be arranged at an angle to the fiber tapes 2 of the first fiber tape layer 3. In addition, the depositing surface 12 can be displaced downwards in the vertical direction 14, whereby the amount of the displacement preferably corresponds to the tape thickness 38.

The actual laying process of the second fiber tape layer 4 can take place as described above, whereby in addition to the hold-down reel 43, the welding head 40 can be pressed against the fiber tape attachment 34 so that the fiber tapes 2 of the second fiber tape layer 4 can be welded to the fiber tapes 2 of the first fiber tape layer 3.

According to the above described process sequences, any number of fiber tape layers can be built up.

Subsequently, the depositing device 7 can be displaced out of the area of the laying device 6 in the laying direction 18 so that the laid scrim 5 consisting of individual fiber tape layers 3, 4 can be removed from the depositing surface 12 by means of the manipulation device. Afterwards the depositing device 7 can be moved back into its depositing position.

FIG. 7 shows a further exemplary embodiment of the production system 1. As can be seen from FIG. 7, it can be provided that the individual unwinders 8 are arranged in a first row 44 or in a second row 45, which are offset with respect to one another in the laying direction 18. In this case, the distance between individual adjacent unwinders 8 of one row 44, 45 can be large, whereby the gaps can be filled up by the unwinders 8 of the other row 44, 45. In other words, the unwinders 8 of the first row 44 and the second row 45 may overlap, when viewed in the laying direction 18. Such a design makes it possible to lay each of the fiber tapes 2 in a first laying step, even though the unwinders 8 have a width 46 greater than the width 47 of the fiber tapes 2.

When starting the laying process, the unwinders 8 of the first row 44 and the unwinders 8 of the second row 45 can be arranged on the same linear guide end 20 or 21 and are displaceable in the same laying direction 18. Alternatively, it is also conceivable that, at the start of the laying operation, the unwinders 8 of the first row 44 and the unwinders 8 of the second row 45 are arranged at an opposite linear guide end 20, 21 and are moved in the opposite laying direction 18.

Furthermore, it can be provided that two adjacent unwinders 8 from different rows 44, 45 are fixed or guided on the same linear guide 17.

Analogous to the embodiment variant in FIG. 7, it can of course also be provided that the unwinders 8 are divided into a plurality of rows.

FIG. 8 shows a side view of a further exemplary embodiment of the production system 1. As can be seen from FIG. 8, it can be provided that a reel store 47 is formed for the exchange of raw material reels 11. In particular, a plurality of raw material reels 11 can be stored in the reel store 47 and can be changed into the individual unwinders 8 as required.

Furthermore, it may be provided that each of the unwinders 8 has an integrated circuit 48 by means of which the actuators arranged on the unwinder 8 can be controlled. By means of the integrated circuit 48, the current filling quantity on the raw material reel 11 of the individual unwinders 8 can also be monitored.

Furthermore, it may also be provided that the individual integrated circuits 48 of the individual unwinders 8 are coupled with a central control 49. For example, it is also conceivable that the control commands between the central control 49 and the integrated circuits 48 are transmitted by means of wireless data transmission.

The central control 49 can be used for the higher-level control of the production system 1. Furthermore, it may be provided that the reel store 47 also has an integrated circuit 48, which is coupled to the central control 49. With the integrated circuit 48 of the reel store 47, the filling level of available raw material reels 11 in the reel store 47 can be monitored or the actuators in the reel store 47 can be controlled.

Furthermore, it can be provided that the central control 49 is coupled to a computer 51 by means of a network 50. The network 50 can, for example, be embodied internally or connected to the Internet. In this case, it is conceivable, for example, that order processes for raw material reels 11 are automatically triggered by the production system 1 if the reel store 47 falls below a minimum reel stock. In addition, it may be provided that new production orders can be fed into the central control 49 of the production system 1 via the network 50. In addition, it is also conceivable that the current status or the current production process at production system 1 is queried via the network 50. In addition, the laying process can be optimized so that the filling quantities of the raw material reels 11 are used in the best possible way.

FIG. 9 shows a further exemplary embodiment of the unwinder 8, whereby the cutting unit 27 is shown in a schematic side view. As can be seen from FIG. 9, it can be provided that a cooling device 52 is formed which serves to cool the fiber tape 2 in the area of the cutting unit 27. The cooling device 52 can be used to locally increase the brittleness of fiber tape 2 in the area where it is to be cut off. This makes it easier to cut the fiber tape 2. The cooling device 52 may, for example, be formed to dispense a coolant such as liquid nitrogen.

The embodiments illustrated as examples represent possible variants and it should be pointed out at this stage that the invention is not specifically limited to the variants specifically illustrated, and instead the individual variants may be used in different combinations with one another and these possible variations lie within the reach of the person skilled in this technical field given the disclosed technical teaching.

The protective scope is defined by the claims. However, the description and drawings may be used to assist with interpreting the claims. Individual features or combinations of features from the different embodiments illustrated and described may be construed as independent inventive solutions or solutions proposed by the invention in their own right. The objective underlying the independent inventive solutions may be found in the description.

All the figures relating to ranges of values in the description should be construed as meaning that they include any and all part-ranges, in which case, for example, the range of 1 to 10 should be understood as including all part-ranges starting from the lower limit of 1 to the upper limit of 10, i.e. all part-ranges starting with a lower limit of 1 or more and ending with an upper limit of 10 or less, e.g. 1 to 1.7, or 3.2 to 8.1 or 5.5 to 10.

For the sake of good order, finally, it should be pointed out that, in order to provide a clearer understanding of the structure, elements are illustrated to a certain extent out of scale and/or on an enlarged scale and/or on a reduced scale.

List of reference numbers

| | |
|---|---|
| 1 | Production system |
| 2 | Fiber tape |
| 3 | First fiber tape layer |
| 4 | Second fiber tape layer |
| 5 | Scrim |
| 6 | Laying device |
| 7 | Depositing device |
| 8 | Unwinder |
| 9 | Unwinder receptacle |
| 10 | Receiving device |
| 11 | Raw material reel |
| 12 | Depositing surface |
| 13 | Passage opening |
| 14 | Vertical direction |
| 15 | Distance |
| 16 | Axis of rotation |
| 17 | Linear guide |
| 18 | Laying direction |
| 19 | Portal |
| 20 | First linear guide end |
| 21 | Second linear guide end |
| 22 | Drive unit |
| 23 | Transverse direction |
| 24 | Transverse direction guide |
| 25 | Longitudinal direction guide |
| 26 | Clamping unit |
| 27 | Cutting unit |
| 28 | Clamping jaws |
| 29 | Counter-holder |
| 30 | Cutting knife |
| 31 | Counter-holder |
| 32 | Ejection position |
| 33 | Basic position |
| 34 | Tape attachment |
| 35 | Deflection reel arrangement |
| 36 | Deflection reel |
| 37 | Width of fiber tape |
| 38 | Tape thickness |
| 39 | Optical unit |
| 40 | Welding head |
| 41 | Press down skid |
| 42 | Heating element |
| 43 | Hold-down reel |
| 44 | First row |
| 45 | Second row |
| 46 | Wide unwinding direction |
| 47 | Reel store |
| 48 | Integrated circuit |
| 49 | Central control |
| 50 | Network |
| 51 | Computer |
| 52 | Cooling device |

1. A production system (1) for laying fiber tapes (2), comprising the production system (1) comprising:—
a laying device (6) having an unwinder receptacle (9) and at least two unwinders (8) arranged next to one another on the unwinder receptacle (9), which unwinders (8) each comprise a receiving device (10) for receiving a raw material reel (11) and a cutting unit (27) for cutting the fiber tape (2);—
a depositing device (7) having a depositing surface (12) for receiving the fiber tape (2) unwound from the raw material reel (11), the depositing surface (12) of the depositing device (7) and the unwinder (8) of the laying device (6) being displaceable relative to one another in the laying direction (18), whereby the fiber tape (2) can be unwound in stripes onto the depositing surface (12),
wherein
the at least two unwinders (8) are each coupled to an unwinder receptacle (9) of the laying device (6) by means of a linear guide (17) and are movable independently of each other in the laying direction (18) relative to the unwinder receptacle (9).

2. The production system according to claim 1, wherein the unwinders (8) each have a welding head (40) which is formed for welding two fiber tapes (2) laid one on top of the other.

3. The production system according to claim 2, wherein the welding head (40) comprises at least one pressing-down skid (41) and in particular a heating element (42) for heating the pressing-down skid (41).

4. The production system according to claim 1, wherein the depositing surface (12) of the depositing device (7) is height-adjustable in a vertical direction (14) so that the distance (15) of the depositing surface (12) from the unwinders (8) can be adapted.

5. The production system according to claim 1, wherein the depositing surface (12) of the depositing device (7) is displaceable in transverse direction (23) to the laying direction (18).

6. The production system according to claim 1, wherein the depositing surface (12) of the depositing device (7) is rotatable about an axis of rotation (16) perpendicular to the depositing surface (12).

7. The production system according to claim 1, wherein each of the individual unwinders (8) is coupled to a drive unit (22), in particular to a linear motor, by means of which the unwinders (8) can be displaced independently of one another in the laying direction (18).

8. The production system according to claim 7, wherein each of the unwinders (8) is assigned its own integrated circuit (48), the individual integrated circuits (48) being coupled to a superordinate central control (49).

9. The production system according to claim 1, wherein a cooling device (52) is arranged in the area of the cutting unit (27), by means of which the fiber tape (2) can be cooled.

10. A method for laying fiber tapes (2) using the production system (1) according to claim 1, wherein the method comprises the following method steps:—
providing a laying device (6) having at least two unwinders (8) arranged next to one another, which unwinders (8) each comprise a receiving device (10) for receiving a raw material reel (11) of a fiber tape (2) and a cutting unit (27) for cutting the fiber tape (2), wherein the at least two unwinders (8) are each coupled by means of a linear guide (17) to an unwinder receptacle (9) of the laying device (6) and are movable independently of one another in the laying direction (18) relative to the unwinder receptacle (9);—
providing a depositing device (7) with a depositing surface (12);
applying the fiber tape (2) of a first of the unwinders (8) to the depositing surface (12) of the depositing device (7);
fixing the fiber tape (2) of the first unwinder (8) on the depositing surface (12) of the depositing device (7);—
unwinding the fiber tape (2) of the first unwinder (8) by displacing the first unwinder (8) in the laying direction (18), the fiber tape (2) is thereby unwound onto the depositing surface (12) in such a way that it is fixed on the depositing surface (12) and is drawn off therefrom by the displacement of the first unwinder (8);
cutting the fiber tape (2) to length by means of the cutting unit (27) of the first unwinder (8);
applying the fiber tape (2) of a second of the unwinders (8) to the depositing surface (12) of the depositing device (7);
fixing the fiber tape (2) of the second unwinder (8) on the depositing surface (12) of the depositing device (7);—
unwinding the fiber tape (2) of the second unwinder (8) by displacing the second unwinder (8) in the laying direction (18), wherein the fiber tape (2) is thereby unwound onto the depositing surface (12) in such a way that it is fixed on the depositing surface (12) and is drawn off from the latter by the displacement of the second unwinder (8);
cutting the fiber tape (2) to length by means of the cutting unit (27) of the second unwinder (8),
wherein the individual steps of the first unwinder (8) and the second unwinder (8) can be started at different times or at the same time.

11. The method according to claim 10, wherein the fiber tapes (2) of a first fiber tape layer (3) are fixed directly on the depositing surface (12) of the depositing device (7) on an intermediate layer and then the fiber tapes (2) of a second fiber tape layer (4) are applied to the fiber tapes (2) of the first fiber tape layer (3), wherein each of the fiber tapes (2) of the second fiber tape layer (4) is at least partially integrally bonded to the fiber tapes (2) of the first fiber tape layer (3) by means of a welding head (40) arranged on the unwinder (8).

12. The method according to claim 10, wherein the number of unwinders (8) is less than the number of fiber tapes (2) provided per fiber tape layer (3, 4) and wherein in a first method step only every second fiber tape (2) of a fiber tape layer (3, 4) is laid, then the depositing surface (12) of the depositing device (7) is displaced in transverse direction (23) to the laying direction (18), and subsequently, in a further method step, the intermediate, missing fiber tapes (2) of a fiber tape layer (3, 4) are laid.

13. The method according to claim 10, wherein the residual length of the fiber tape (2) on the raw material reel (11) is constantly monitored and wherein before the start of laying the fiber tapes (2) it is calculated whether the residual length of the fiber tape (2) on the raw material reel (11) is sufficient for the upcoming laying operation, wherein a raw material reel (11) located in a reel store (47) is exchanged as required.

14. The method according to claim 10, wherein the stock of raw material reels (11) located in a reel store (47) and/or the tape lengths located on the raw material reels (11) is monitored, wherein, when a predefined minimum of raw material reels (11) or tape lengths is reached, an order process is triggered in which a command is sent from the central control (49) to a computer (51) located in a network (50).

15. The method according to claim 10, wherein the unwinders (8) are stopped or at least greatly decelerated in their traversing movement when the fiber tape (2) is fixed on the depositing surface (12) of the depositing device (7).
